(19) United States
(12) Patent Application Publication
(10) Pub. No.: US 2025/0215576 A1
(43) Pub. Date: Jul. 3, 2025

(54) INCREASED OXYGEN OUTLET PRESSURE IN AN ELECTROLYZER

(71) Applicant: Kyros Hydrogen Solution s GmbH, Fõritztal (DE)

(72) Inventor: Matthias Böhm, Föritztal (DE)

(21) Appl. No.: 18/988,171

(22) Filed: Dec. 19, 2024

Related U.S. Application Data
(60) Provisional application No. 63/616,186, filed on Dec. 29, 2023.
(60) Provisional application No. 63/626,281, filed on Jan. 29, 2024.

(51) Int. Cl. C25B 1/04; C25B 15/025; C25B 15/08

(52) U.S. Cl. CPC C25B 1/04; C25B 15/025; C25B 15/081; C25B 15/083; C25B 15/087

(57) ABSTRACT

Systems and methods for increased oxygen output from an electrolyzer system are provided. The electrolyzer system includes a water storage tank. The electrolyzer system also includes an electrolyzer in fluid communication with the water storage tank and configured to produce oxygen and hydrogen from water e.g., (H₂O). The electrolyzer system also includes one or more pressure isolating components configured to increase the oxygen output pressure of the system by pressure isolating the water storage tank from the electrolyzer stack.

### PRIORITY CLAIM

The present application is based on and claims priority to U.S. Provisional Application 63/616,186 having a filing date of Dec. 29, 2023 and U.S. Provisional Application 63/626,281 having a filing date of Jan. 29, 2024, both of which are incorporated by reference herein.

### FIELD

Aspects of the present disclosure relates generally to an electrolyzer system.

### BACKGROUND

Electrolyzer systems use electricity to produce hydrogen and oxygen from H₂O.

### SUMMARY

Aspects and advantages of embodiments of the present disclosure will be set forth in part in the following description, or may be learned from the description, or may be learned through practice of the embodiments.

One example aspect of the present disclosure is directed to an electrolyzer system. The electrolyzer system includes a water storage tank configured to store water. The electrolyzer system further includes an electrolyzer in fluid communication with the water storage tank, the electrolyzer configured to generate a water-oxygen mixture from the water. The electrolyzer system further includes a pressure reducer configured to reduce pressure of the water upstream of the of the electrolyzer, the pressure reducer located between the water storage tank and the electrolyzer. The electrolyzer system further includes a post-stack pump configured to increase pressure of the water-oxygen mixture downstream of the electrolyzer.

Another example aspect of the present disclosure is directed to a method for producing high-pressure oxygen in an electrolyzer. The method includes reducing, by a pressure reducer, pressure of water upstream of an electrolyzer, the electrolyzer configured to generate a water-oxygen mixture from the water. The method further includes increasing, by a post-stack pump, pressure of the water-oxygen mixture downstream of the electrolyzer.

Another example aspect of the present disclosure is directed to a fluid circuit for an electrolyzer system. The fluid circuit includes a water storage tank configured to store water. The fluid circuit further includes an electrolyzer in fluid communication with the water storage tank, the electrolyzer configured to generate a water-oxygen mixture from the water. The electrolyzer is pressure isolated from the water storage tank through one or more controllable pressure isolating components.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram view of an example electrolyzer system according to example embodiments of the present disclosure;

FIG. 2 depicts a diagram view of an example electrolyzer system according to example embodiments of the present disclosure;

FIG. 3 depicts a diagram view of an example electrolyzer system according to example embodiments of the present disclosure; and

FIG. 4 depicts a flow chart diagram of an example method for producing high-pressure oxygen in an electrolyzer system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value is intended to refer to within 10% of the numerical value. As used herein, the terms “upstream” and “downstream” are used to specify a position along a flow path relative to a component in reference to the flow direction of a fluid. Specifically, the term “downstream” refers to a position located apart from a component along the flow path in the direction the fluid is flowing while the term “upstream” refers to a position that is located apart from the component along the flow path in a direction that is opposite the direction the fluid is flowing.

Example aspects of the present disclosure are directed to an electrolyzer system with a high oxygen output pressure. Electrolyzer systems produce oxygen (e.g., oxygen gas) from liquid water (e.g., H₂O) through the process of electrolysis. A high oxygen output pressure from the electrolyzer system may be advantageous to downstream application possibilities such as gas treatment, chemical or physical processes, or simply the storage of oxygen. In addition, the compression of the oxygen at subsequent processes may be reduced or rendered obsolete.

In some instances, the output pressure of the oxygen produced by an electrolyzer system is limited by pressure-sensitive components (e.g., electrolyzer stack) within the electrolyzer system that may be configured to operate within a set pressure range. Accordingly, a way of increasing the output pressure of the electrolyzer system while keeping pressure-sensitive components (e.g., electrolyzer stack) within an acceptable pressure range would be beneficial.

Aspects of the present disclosure provide an electrolyzer system that may increase the output pressure of the electrolyzer system while keeping pressure-sensitive components (e.g., electrolyzer stack) within an acceptable pressure range.

Example aspects of the present disclosure provide a number of technical effects and benefits. For instance, many electrolyzer systems may have a maximum oxygen output pressure that is limited by pressure-sensitive components such as the electrolyzer stack. The electrolyzer system of the present disclosure allows for pressure-sensitive components to be pressure isolated from the rest of the system, allowing for a significantly higher pressure in the part of the system outputting the oxygen to downstream applications, such as treatment applications (e.g., sewage treatment applications).

Referring now to the figures, example aspects of the present disclosure will be discussed in greater detail.

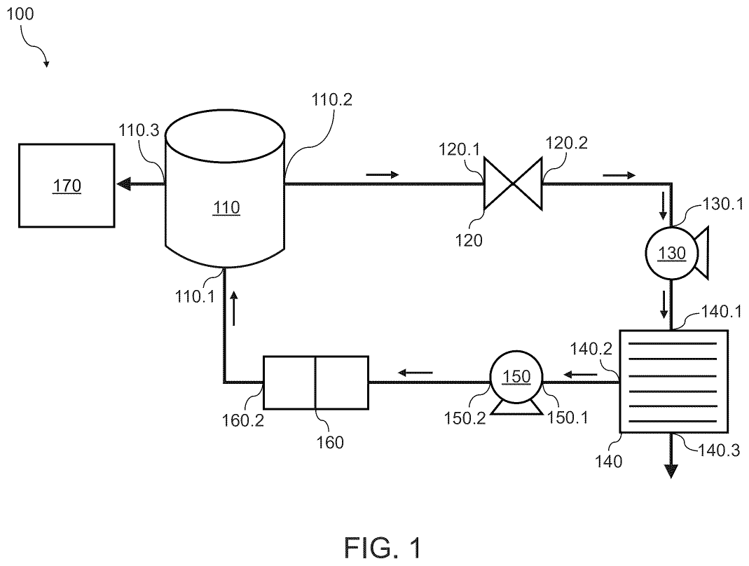

FIG. 1 depicts a block diagram depicting an electrolyzer system 100 according to example embodiments of the present disclosure. The electrolyzer system 100 may include a water storage tank 110 configured to supply liquid water downstream via outlet 110.2.

The electrolyzer system 100 may also include an electrolyzer stack 140 (e.g., electrolyzer). In some embodiments, electrolyzer stack 140 may be a Proton Exchange Membrane (PEM) electrolyzer stack. In other embodiments, electrolyzer stack 140 may be an Alkaline electrolyzer stack. Those skilled in the art will understand that any suitable electrolyzer stack or electrolyzer chemistries may be used without deviating from the scope of the present disclosure. The electrolyzer stack 140 is in fluid communication with the water storage tank 110. The electrolyzer stack 140 is configured to generate a water-oxygen mixture from liquid water. Specifically, the electrolyzer stack 140 receives liquid water at stack inlet 140.1 and produces the water-oxygen mixture downstream via stack outlet 140.2. In some embodiments, electrolyzer stack 140 may further generate hydrogen (e.g., H₂ molecules) from the liquid water to be output via stack outlet 140.3 to a downstream system to be used, for example, as hydrogen fuel.

The electrolyzer system 100 may also include a pressure reducer 120 located downstream of the water storage tank 110. The pressure reducer 120 is configured to reduce the pressure of the water downstream of the pressure reducer. As such, the pressure reducer 120 may ensure that the pressure within the water storage tank 110 (e.g., at inlet 120.1) is greater than the pressure downstream of the pressure reducer 120 (e.g., at outlet 120.2). In some embodiments, the pressure reducer 120 may include one or more valves configured to reduce the pressure from inlet 120.1 to outlet 120.2.

In some embodiments, the electrolyzer system 100 may further include a pre-stack pump 130 located upstream of the electrolyzer stack 140 between the pressure reducer 120 and the electrolyzer stack 140. The pre-stack pump 130 may be configured to control the pressure of the water supplied to the electrolyzer stack 140 at stack inlet 140.1. In some embodiments, the pre-stack pump 130 is configured to increase (e.g., regulate) the pressure of the water supplied to the electrolyzer stack 140 based, at least in part, on the pressure inside the water storage tank 110.

The electrolyzer system 100 may also include a post-stack pump 150 located downstream of the electrolyzer stack 140. The post-stack pump 150 receives, from the electrolyzer stack 140, a water-oxygen mixture e.g., (liquid H₂O and oxygen gas) at post-stack pump inlet 150.1. The post-stack pump 150 is configured to increase the pressure of the water-oxygen mixture downstream of the post-stack pump (e.g., at post-stack pump outlet 150.2). As the water storage tank 110 may be located downstream of the post-stack pump, the post-stack pump 150 may increase (e.g., regulate) the pressure inside the water storage tank 110. As such, the pressure within water storage tank 110 may be dependent on the post-stack pump 150. In some embodiments, the post-stack pump 150 is configured to increase pressure within the water storage tank 110 to a pressure greater than 10 bars, such as to a pressure greater than 15 bars, such as to about 20 bars.

In some embodiments, the post-stack pump is configured to supply the water-oxygen mixture to a water-oxygen separator 160. The water-oxygen separator 160 is configured to separate the water (e.g., liquid H₂O) from the oxygen (e.g., oxygen gas). The water-oxygen separator 160 may supply the separated water (e.g., liquid H₂O) and/or the oxygen (e.g., oxygen gas) to the water storage tank 110 via separator outlet 160.2.

The oxygen (e.g., oxygen gas) may be output from the water storage tank 110 via outlet 110.3 to a downstream system 170 such as a downstream sewage treatment system or an oxygen storage facility. In some embodiments, the oxygen is delivered to the downstream system 170 at a pressure defined by the pressure of the water-oxygen mixture at post-stack pump outlet 150.2. As such, the post-stack pump 150 may increase (e.g., control) the pressure inside water storage tank 110 as well as the pressure of the oxygen gas output from the electrolyzer system 100.

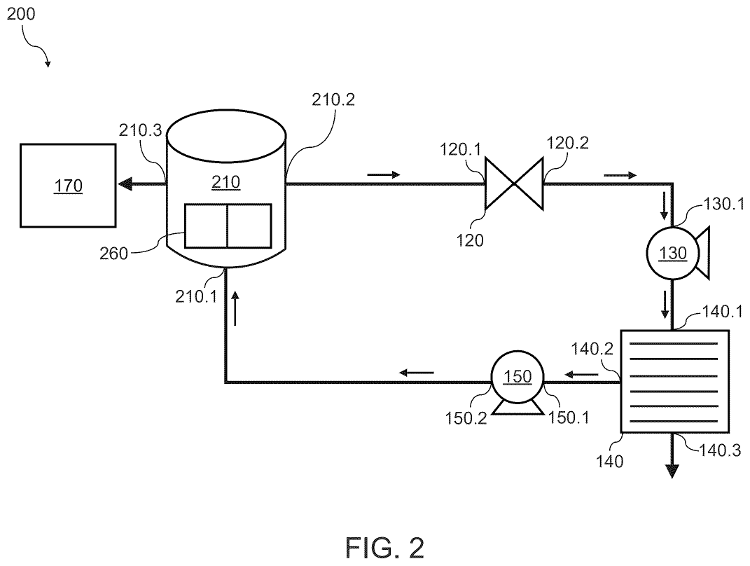

FIG. 2 depicts another block diagram representation of an electrolyzer system 200 according to example embodiments of the present disclosure. The electrolyzer system 200 includes various components discussed with reference to FIG. 1, including pressure reducer 120, pre-stack pump 130, electrolyzer stack 140, post-stack pump 150, and downstream system 170. Except where otherwise indicated, these like reference numerals are used to represent like components, and description with respect to the electrolyzer system 100 of FIG. 1 is equally intended to apply to the electrolyzer system 200 of FIG. 2.

Electrolyzer system 200 may include water storage tank 210 configured to supply liquid water to electrolyzer stack 140 via outlet 210.2. Water storage tank 210 may further receive a water-oxygen mixture at inlet 210.1 from post-stack pump 150. Water storage tank 210 may separate the water-oxygen mixture supplied from the post-stack pump with water-oxygen separator 260. The separated water (e.g., liquid H₂O) may then be returned to the electrolyzer stack 140 via outlet 210.2 while the oxygen (e.g., oxygen gas) may output the system via outlet 210.3 to, for example, downstream system 170. The oxygen may be delivered to the downstream system 170 at a pressure defined by the pressure of the water-oxygen mixture at post-stack pump outlet 150.2. The post-stack pump 150 increases (e.g., controls) the pressure inside water storage tank 210 as well as the pressure of the oxygen gas output from the electrolyzer system 200. As such, the pressure within water storage tank 210 is dependent on the post-stack pump 150. In some embodiments, the post-stack pump 150 is configured to increase pressure within the water storage tank 210 to a pressure greater than 10 bars, such as to a pressure greater than 15 bars, such as to about 20 bars.

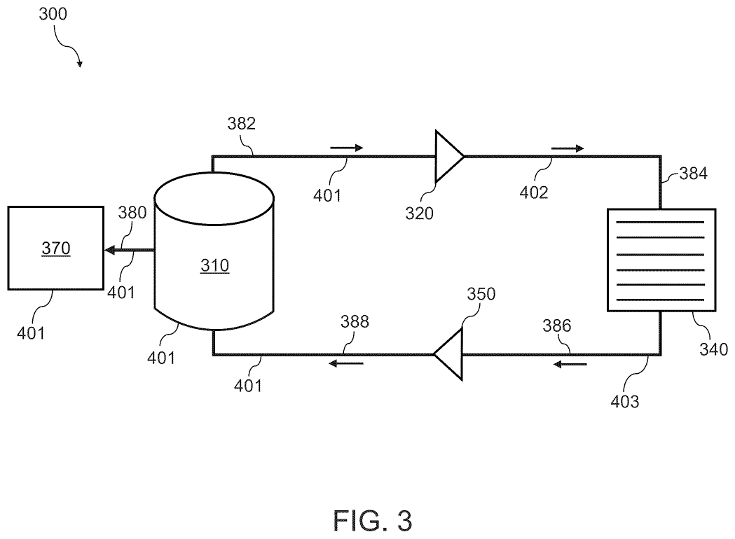

FIG. 3 depicts a block diagram of a fluid circuit 300 for an example electrolyzer system such as electrolyzer system 100 shown in FIG. 1 or electrolyzer system 200 shown in FIG. 2. Fluid circuit 300 includes a water storage tank 310 configured to store water. Fluid circuit 300 also includes electrolyzer stack 340 (e.g., electrolyzer) configured to generate a water-oxygen mixture from the water. Electrolyzer stack 340 is in fluid communication with water storage tank 310 via fluid conduits 382, 384, 386, and 388.

Fluid circuit 300 may further include pressure isolating components 320, 350 configured to pressure-isolate water storage tank 310 from electrolyzer stack 340. Water storage tank 310 may supply liquid water to pressure isolating component 320 via fluid conduit 382. Pressure isolating component 320 may be a controllable pressure isolating component configured to regulate or control the pressure of liquid water supplied to electrolyzer stack 340 via fluid conduit 384. In some embodiments, pressure isolating component 320 may include one or more valves. Additionally or alternatively, pressure isolating component 320 may include one or more pumps. In some embodiments, pressure isolating component 320 may include pressure reducer 120 and pre-stack pump 130 as described in FIG. 1 and/or FIG. 2.

Electrolyzer stack 340 may supply a water-oxygen mixture to pressure isolating component 350 via fluid conduit 386. Pressure isolating component 350 may be a controllable pressure isolating component configured to regulate or control the pressure of the water-oxygen mixture supplied to the water storage tank 310 via fluid conduit 388. As such, the pressure within water storage tank 310 is dependent on pressure isolating component 350. In some embodiments, the pressure isolating component 350 is configured to increase pressure within the water storage tank 310 to a pressure greater than 10 bars, such as to a pressure greater than 15 bars, such as to about 20 bars. In some embodiments, pressure isolating component 350 may include one or more valves. Additionally or alternatively, pressure isolating component 350 may include one or more pumps such as post-stack pump 150 described in FIG. 1 and/or FIG. 2.

Fluid circuit 300 may further be described by the pressure at different portions of the electrolyzer system (e.g., pressure regions) wherein the pressure within each pressure region may be constant. For example, pressure region 401 may be defined between pressure isolating components 350 and 320. Pressure region 402 may be defined between pressure isolating component 320 and electrolyzer stack 340. Further, pressure region 403 may be defined between electrolyzer stack 340 and pressure isolating component 350. Pressure region 401 may be controlled or regulated by pressure isolating component 350. For example, pressure isolating component 350 may control (e.g., set) the pressure of pressure region 401 based on a desired oxygen output pressure of downstream system 370. Pressure isolating component 320 may then decrease the pressure from pressure region 401 to 402 based, at least in part, on the pressure in pressure region 401 and/or a maximum input pressure rating of the electrolyzer stack 340. In some embodiments, pressure from pressure region 402 to 403 may decrease from principle-related pressure losses in the electrolysis process. Accordingly, pressure isolating component 350 may regulate pressure in pressure region 401 based on pressure losses in the electrolyzer stack 340.

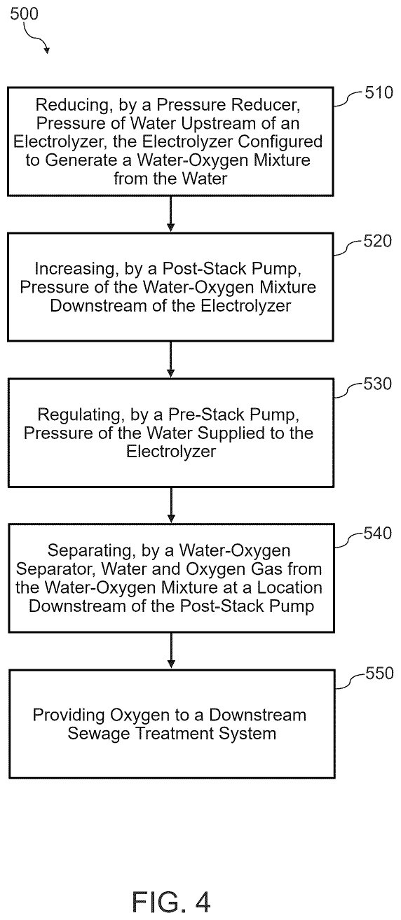

Referring now to FIG. 4, a flowchart of a method 500 for an example method for producing high-pressure oxygen according to example embodiments of the present disclosure is provided. More particularly, the method 500 can be implemented by an electrolyzer system (e.g., as depicted in FIGS. 1-2) using a fluid circuit (e.g., as depicted in FIG. 3). FIG. 5 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 500 is generally discussed with reference to the electrolyzer systems 100, 200 described above with reference to FIGS. 1-2 and the fluid circuit 300 described above with reference to FIG. 3. However, it should be understood that aspects of the present method 500 can be implemented with any electrolyzer system and/or fluid circuit.

The method 500 can include, at 510, reducing, by a pressure reducer, pressure of water upstream of an electrolyzer, the electrolyzer configured to generate a water-oxygen mixture from the water.

At 520, method 500 may further include increasing, by a post-stack pump, pressure of the water-oxygen mixture downstream of the electrolyzer. At 530, method 500 may further include regulating, by a pre-stack pump, pressure of the water supplied to the electrolyzer. At 540, method 500 may further include separating, by a water-oxygen separator, water and oxygen gas from the water-oxygen mixture at a location downstream of the post-stack pump. In some embodiments, the water-oxygen separator may be configured to supply water to a water storage tank, the water storage tank configured to store water. At 550, method 500 may further include providing oxygen to a downstream sewage treatment system.

One example aspect of the present disclosure is directed to an electrolyzer system. The electrolyzer system includes a water storage tank configured to store water. The electrolyzer system further includes an electrolyzer in fluid communication with the water storage tank, the electrolyzer configured to generate a water-oxygen mixture from the water. The electrolyzer system further includes a pressure reducer configured to reduce pressure of the water upstream of the of the electrolyzer, the pressure reducer located between the water storage tank and the electrolyzer. The electrolyzer system further includes a post-stack pump configured to increase pressure of the water-oxygen mixture downstream of the electrolyzer.

In some embodiments, the electrolyzer system may further include a pre-stack pump located between the pressure reducer and the electrolyzer, the pre-stack pump configured to control pressure of the water supplied to the electrolyzer.

In some embodiments, the pre-stack pump is configured to increase the pressure of the water supplied to the electrolyzer.

In some embodiments, the electrolyzer system may further include a water-oxygen separator located downstream of the post-stack pump.

In some embodiments, the water-oxygen separator is configured to: separate water and oxygen gas from the water-oxygen mixture; and supply the water to the water storage tank.

In some embodiments, the pressure within the water storage tank is dependent on the post-stack pump.

In some embodiments, the post-stack pump is configured to increase pressure within the water storage tank to a pressure greater than 10 bars.

In some embodiments, the pressure reducer comprises one or more valves.

In some embodiments, the electrolyzer system is configured to provide oxygen to a downstream sewage treatment system.

Another example aspect of the present disclosure is directed to a method for producing high-pressure oxygen in an electrolyzer. The method includes reducing, by a pressure reducer, pressure of water upstream of an electrolyzer, the electrolyzer configured to generate a water-oxygen mixture from the water. The method further includes increasing, by a post-stack pump, pressure of the water-oxygen mixture downstream of the electrolyzer.

In some embodiments, the method further includes regulating, by a pre-stack pump, pressure of the water supplied to the electrolyzer.

In some embodiments, the pre-stack pump is configured to increase the pressure of the water supplied to the electrolyzer.

In some embodiments, the method further includes separating, by a water-oxygen separator, water and oxygen gas from the water-oxygen mixture at a location downstream of the post-stack pump.

In some embodiments, the water-oxygen separator is configured to supply water to a water storage tank, the water storage tank configured to store water.

In some embodiments, the pressure within the water storage tank is dependent on the post-stack pump.

In some embodiments, the post-stack pump is configured to increase pressure within the water storage tank to a pressure greater than 10 bars.

In some embodiments, the pressure reducer comprises one or more valves.

In some embodiments, the method further includes providing oxygen to a downstream sewage treatment system.

Another example aspect of the present disclosure is directed to a fluid circuit for an electrolyzer system. The fluid circuit includes a water storage tank configured to store water. The fluid circuit further includes an electrolyzer in fluid communication with the water storage tank, the electrolyzer configured to generate a water-oxygen mixture from the water. The electrolyzer is pressure isolated from the water storage tank through one or more controllable pressure isolating components.

In some embodiments, the pressure within the water storage tank is greater than pressure within the electrolyzer.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An electrolyzer system comprising:
a water storage tank configured to store water;
an electrolyzer in fluid communication with the water storage tank, the electrolyzer configured to generate a water-oxygen mixture from the water;
a pressure reducer configured to reduce pressure of the water upstream of the of the electrolyzer, the pressure reducer located between the water storage tank and the electrolyzer; and
a post-stack pump configured to increase pressure of the water-oxygen mixture downstream of the electrolyzer.

2. The electrolyzer system of claim 1, the electrolyzer system further comprising:
a pre-stack pump located between the pressure reducer and the electrolyzer, the pre-stack pump configured to control pressure of the water supplied to the electrolyzer.

3. The electrolyzer system of claim 2, wherein the pre-stack pump is configured to increase the pressure of the water supplied to the electrolyzer.

4. The electrolyzer system of claim 1, the electrolyzer system further comprising: a water-oxygen separator located downstream of the post-stack pump.

5. The electrolyzer system of claim 4, wherein the water-oxygen separator is configured to:
separate water and oxygen gas from the water-oxygen mixture; and
supply the water to the water storage tank.

6. The electrolyzer system of claim 5, wherein pressure within the water storage tank is dependent on the post-stack pump.

7. The electrolyzer system of claim 5, wherein the post-stack pump is configured to increase pressure within the water storage tank to a pressure greater than 10 bars.

8. The electrolyzer system of claim 1, wherein the pressure reducer comprises one or more valves.

9. The electrolyzer system of claim 1, wherein the electrolyzer system is configured to provide oxygen to a downstream sewage treatment system.

10. A method for producing high-pressure oxygen in an electrolyzer, the method comprising:
reducing, by a pressure reducer, pressure of water upstream of an electrolyzer, the electrolyzer configured to generate a water-oxygen mixture from the water; and
increasing, by a post-stack pump, pressure of the water-oxygen mixture downstream of the electrolyzer.

11. The method of claim 10, the method further comprising:
regulating, by a pre-stack pump, pressure of the water supplied to the electrolyzer.

12. The method of claim 11, wherein the pre-stack pump is configured to increase the pressure of the water supplied to the electrolyzer.

13. The method of claim 10, the method further comprising:
separating, by a water-oxygen separator, water and oxygen gas from the water-oxygen mixture at a location downstream of the post-stack pump.

14. The method of claim 13, wherein the water-oxygen separator is configured to supply water to a water storage tank, the water storage tank configured to store water.

15. The method of claim 14, wherein pressure within the water storage tank is dependent on the post-stack pump.

16. The method of claim 14, wherein the post-stack pump is configured to increase pressure within the water storage tank to a pressure greater than 10 bars.

17. The method of claim 10, wherein the pressure reducer comprises one or more valves.

18. The method of claim 10, further comprising:
providing oxygen to a downstream sewage treatment system.

19. A fluid circuit for an electrolyzer system, comprising:
a water storage tank configured to store water; and
an electrolyzer in fluid communication with the water storage tank, the electrolyzer configured to generate a water-oxygen mixture from the water;
wherein the electrolyzer is pressure isolated from the water storage tank through one or more controllable pressure isolating components.

20. The fluid circuit of claim 19, wherein pressure within the water storage tank is greater than pressure within the electrolyzer.
